(19) United States
(12) Patent Application Publication
(10) Pub. No.: US 2022/0277259 A1
(43) Pub. Date: Sep. 1, 2022

(54) PROFORMA DISBURSEMENT SYSTEM AND METHOD

(71) Applicant: DA-Desk FZE, Dubai (AE)

(72) Inventors: BRUNO DESZCZYNSKI, Dubai (AE); Alan Cassar, Dubai (AE)

(73) Assignee: DA-Desk FZE, Dubai (AE)

(21) Appl. No.: 17/746,821

(22) Filed: May 17, 2022

Related U.S. Application Data
(63) Continuation-in-part of application No. 16/534,245, filed on Aug. 7, 2019.
(60) Provisional application No. 62/718,896, filed on Aug. 14, 2018.

(51) Int. Cl. G06Q 10/08; G06Q 10/06; G06Q 10/04; G06F 40/279

(52) U.S. Cl. CPC G06Q 10/0831; G06Q 10/0838; G06Q 10/08345; G06Q 10/06375; G06Q 10/047; G06F 40/279; G06Q 50/30

(57) ABSTRACT

A system for generating proforma disbursement accounts including a structured data source, said data source including historical port call cost information for both tariffed and non-tariffed costs; a similarity engine operable to compare historical tariffed items against a proposed port call disbursement account to estimate a tariffed item cost, and any surcharges, and a correlation engine, said correlation engine operable to estimate, based on historical costs, estimated costs for non-tariffed port call items. Natural language processing may be employed for some cost information. Collectively, these elements operate to estimate costs for non-tariffed items and, with the tariffed item costs, effectuate a synthetic proforma disbursement account for a vessel's port of call.

### PRIORITY

This application is a continuation-in-part of co-pending U.S. patent application Ser. No. 16/534,245 filed Aug. 7, 2019, which claims the benefit of provisional patent application 62/718,896 filed on Aug. 14, 2018 by the same inventors which is included by reference, together with its appendix, as if fully set forth herein.

### BACKGROUND

Port Costs are crucial elements of a maritime vessel's voyage expenses. They form the 3rd largest voyage cost and largely drive the end-price of goods being transported. Shipping companies often rely on agencies to predict and control port costs. This reliance on agencies may expose a shipping company to potential corruption as the organization delivering services in the port is also the controller. Accordingly, there should be an independent, more transparent and less corruption-prone method of calculating port costs independent of the parties delivering the port services. Through the years, the cost of port services around the world has increased in varying magnitudes. However, the ability of shipping companies to track and analyze voyage port cost changes remains rudimentary. Current systems do not possess the functionality required by the stakeholders to effectively and efficiently estimate port-costs, which adds instability to international pricing.

A Proforma Disbursement Account (PDA) is a cost estimate statement sent by a ship's agent at a port to the shipowner in advance of the ship's call at the port. Conventionally, it consists of the expenses that are likely to be incurred, including, but not limited to, port charges, pilotage, towage and the agent's commission. This account is used to help the ship owner estimate the viability of a voyage and serves as a request by the agent for sufficient funds to be made available prior to the ship's arrival.

Among the items listed in the PDA are tariffed and non-tariffed costs. A tariffed item is one where the exact cost of the service is published by either the port authority or some similar entity and is made publicly available to everyone. Each port generally makes its tariffs available to potential port users. Although, in some instances, tariffed items are static, tariffed items are generally based on parameters which are not static, such as total number of days the vessel will stay in port, total number of tugs used, total number of hours or distance of pilotage, and similar costs. Because these costs are often variable, it is impossible to apply the tariff to estimate the port costs in advance without more information.

There are two types of non-tariffed items. The first one is where a vessel operator and a service provider sign an agreement and define how much the service will cost. This may be referred to as a customer-specific tariff. The second type of non-tariffed items is where there is no agreement, and the service provider charges how much he believes is correct or uses a figure that is not publicly available. Often, non-tariffed items may be known in advance and available for the PDA. Examples of non-tariffed items may be agency fees, launch services, communications, emergency situations, and the like.

Because non-tariffed items are not known in advance and tariffed item costs may widely vary, shippers cannot know the cost of a port call in advance. Moreover, rapidly changing international financial conditions may modify the profitability of a proposed voyage and, therefore, alter the financial decision-making of whether a voyage should commence, or if voyage specifications should change. Accordingly, better tools are needed for vessel port call planning and management.

In addition to tariffed items there may also be surcharges for providing services after working hours, on weekends, and on official holidays. In more rare cases there are surcharges for staying idle at berth. However, these costs are not very evident when a PDA is initially provided as the arrival time often cannot be guaranteed. Accordingly, planning the vessel's arrival carefully may allow operators to partially or completely bypass these additional costs related to timing of the port operations.

In some embodiments natural language processing may be employed to translate human data entries into relevant costs. Proforma disbursement account may then reflect the human data entries.

### BRIEF DESCRIPTION OF THE DRAWINGS

FIG. 1 shows a functional block diagram of a client server system.

FIG. 2 shows an illustration of certain steps that may be employed to effectuate an embodiment according to the current disclosure.

FIG. 3 shows a representation of a user interface which may be employed in some embodiments.

### SUMMARY

A system for generating proforma disbursement accounts including a structured data store, said data store including historical port call cost information for both tariffed and non-tariffed costs; a similarity engine operable to compare historical tariffed items against a proposed port call disbursement account to estimate a tariffed item cost; and a correlation engine, said correlation engine operable to estimate, based on historical costs, estimated costs for non-tariffed port call items. Collectively, these elements operate to estimate costs for non-tariffed items and with the tariffed item costs, effectuate a synthetic proforma disbursement account for a vessel's port of call.

Further included are embodiments to estimating surcharges and days of the week or years where surcharges are applied using disbursement account historical data and other sources.

The system described herein provides an aid for worldwide maritime vessel management for rapidly changing international financial conditions. The use of a synthetic proforma disbursement account assists in developing pricing and other operational parameters for a voyage. For example, and without limitation, whether a voyage should commence, or if voyage specifications should change.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, smartphones, personal digital assistants (PDAs) and the like.

The processing system may also include mass storage devices such as disk drives and flash memory modules as well as connections through I/O devices to servers or remote processors containing additional storage devices and peripherals.

Certain embodiments may employ multiple servers and data storage devices, thus allowing for operation in a cloud or for operations drawing from multiple data sources. The inventors contemplate that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smartphone, PDA, laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

The methods and techniques described herein may be performed on a processor-based device. The processor-based device will generally comprise a processor attached to one or more memory devices or other tools for persisting data. These memory devices will be operable to provide machine-readable instructions to the processors and to store data, including data acquired from remote servers.

### Client Server Processing

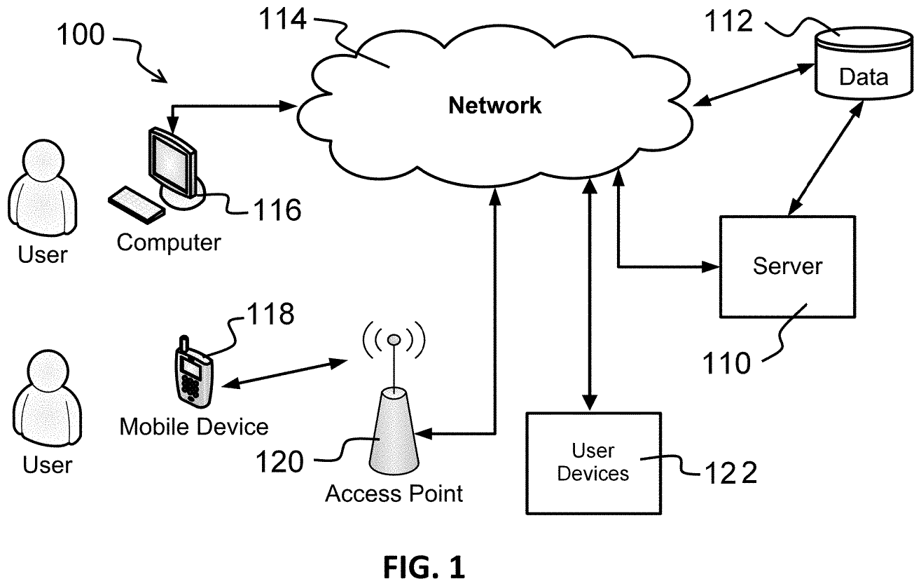

FIG. 1 shows a functional block diagram of a client server system 100 that may be employed for some embodiments according to the current disclosure. In the FIG. 1, a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively, the user may access the server 110 through the network 114 by using a smart device such as a telephone or PDA 118. The smart device 118 may connect to the server 110 through an access point 120 coupled to the network 114. The mobile device 118 may include a sound capture device such as a microphone. Various other user devices 122 may be coupled to the network.

Conventionally, client server processing operates by dividing the processing between two devices such as a server and a smart device such as a cell phone or other computing device. The workload is divided between the servers and the clients according to a predetermined specification. For example, in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and the client indicates which instructions are transmitted and executed. In addition, the client may, at times, provide for machine-readable instructions to the server, which in turn executes them. Several forms of machine-readable instructions are conventionally known, including applets, and are written in a variety of languages including Java and JavaScript.

Client-server applications also provide for software as a service (SaaS) applications where the server provides software to the client on an as-needed basis.

In addition to the transmission of instructions, client-server applications also include transmission of data between the client and server. Often, this entails data stored on the client to be transmitted to the server for processing. The resulting data is then transmitted back to the client for display or further processing.

One having skill in the art will recognize that client devices may be communicably coupled to a variety of other devices and systems, such that the client receives data directly and operates on that data before transmitting it to other devices or servers. Thus, data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein, a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

### Process

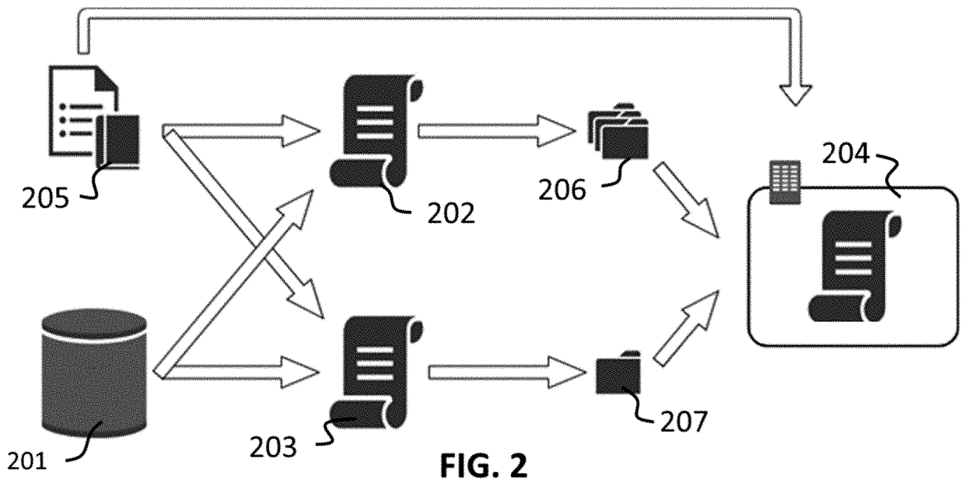

FIG. 2 shows an illustration of certain steps that may be employed to effectuate an embodiment according to the current disclosure. In FIG. 2, item 201 is structured data store including historical cost information, both tariffed and non-tariffed, for a variety of historical port calls. In addition to cost information is vessel and cargo type, port and other shipping information.

In FIG. 2, a proposed PDA 205 is supplied to a processor which is coupled to the data store 201. The processor includes instructions to apply a similarity algorithm 202 for determining tariffed port calls similar to those in the proposed PDA 205. Once the similarity is identified, a list of similar port calls is generated 206 along with a percent similarity.

The processor also receives the proposed PDA 205 and applies a non-tariffed cost model 203 which, using historical cost data 201, provides a predicted non-tariff cost estimate 207.

Both the non-tariffed costs determination 207 and the tariffed cost determinations 206 are presented to a user 204 for review. In some embodiments, however, allowable variances may be predetermined. If the predicted tariffed and non-tariffed costs are within the allowable range, then the PDA is automatically generated. For example, and without limitation, the similarity may be 100% and the non-tariffed cost estimate may be within a predetermined range, so the PDA is generated.

### Similarity Algorithm

The similar port calls algorithm may be staggered, to find perfect matches first, then relax the rules one at a time until there are enough similar disbursement accounts to make an estimate. Every level may have a similarity number attached to it. For example, and without limitation, perfectly matched port calls will be 100% similar. Less similar port calls will have a lower number. Listed herein are different options for generating a port call similarity:

Algorithm 1

1. Perfect match:
a. same port
b. same operator
c. same vessel IMO number (unique ID)
d. same agent
e. same activity
f. within the last 12 months

2. Next level—same as above except:
a. Remove same vessel match
b. Add same vessel type (bulk carrier, oil/chemical . . . )
c. Add same vessel sub type (Handymax, VLCC . . . )

3. Next level same as above except the following:
a. Remove same agent match

4. Next level same as above except the following:
a. Remove same vessel subtype
b. Add deadweight tonnage (DWT)+−25%

5. Next level same as above except the following:
a. Remove same activity
b. Remove same vessel type

6. Next level same as above except the following:
a. Expand ETA to within the past 3 years.

Here, the characteristics which are likely to be the most important for determining similarly are matched and characteristics are removed from the algorithm until the best match is found. At any stage, if there are more port calls than required, preference may be given to most recent port call.

Algorithm 2

1. Perfect match:
a. same port
b. same operator
c. same vessel IMO
d. same agent
e. same activity
f. ETA of today . . . 365 days

2. Next level same as above except the following:
a. Remove same vessel match
b. Add same vessel type (bulk carrier, oil/chemical . . . )
c. Add same vessel sub type (Handymax, VLCC . . . )
d. Add DWT+−5%

3. Next level same as above except the following: (moved from lower level)
a. Remove same agent match

4. Next level same as above except the following:
a. Remove DWT+−5%
b. Add DWT+−10%

5. Next level same as above except the following:
a. Remove DWT+−10%

6. Next level same as above except the following:
a. Remove same vessel subtype
b. Add DWT+−25%

7. Next level same as above except the following:
a. Remove same activity
b. Remove same vessel type

8. Next level same as above except the following:
a. Expand ETA to today—800 days

Different variations on the above themes are shown in the attached Appendix which is included by reference as if fully set forth herein. The cargo parameters and vessel characteristics may all be added or removed from certain algorithms to effectuate a suitable similarity match.

### Non-Tariffed Items Models

Not all non-tariffed items lend themselves to historical comparisons to estimate costs. Accordingly, in some embodiments, items like agency fees and similar fees may require advanced prediction processes. Moreover, some embodiments may employ a custom regression or correlation models operable to generate predicted non-tariffed cost items for similar port calls or for providing cost items values that would allow for synthetic PDA creation and quicker checking of cost items values.

In some embodiments, the regression method may be based on a primary correlation among features like location, country, wet/dry cargo type, vessel-details to cost items. Further, correlation coefficients may be generated for specific locations and for specific countries. Location coefficients may be defined in both US dollars and in local currencies. Exemplary variables include:
Location ID
Cargo Type
Dry weight tonnage
Net register tonnage (NRT)
Gross register tonnage (GRT)
Length overall (LOA)
   The location ID may be for a specific location such as a port or berth in a port, whereas for country-based variables, the country name or code may be used.

By generating a matrix with the above variables, a correlation showing the change in value of the agency fee or any non-tariffed items with respect to the country of location may be created. Once correlation variables are generated for every location and country, a polynomial function using linear regression may be employed. This function may be represented as f(af)=aDWT±bLOA± . . . +c, where a, b, etc., are the coefficients. Accordingly, a representative calculation for determining the agency fee may be:

agency_fee˜a₀·DWT+a₁·DWT^{1/2}+a₂·DWT^{1/3}+a₃·DWT^{2/3}+a₄·NRT+a₅·NRT^{1/2}+a₆·NRT^{1/3}+a₇·NRT^{2/3}+a₈·GRT+a₉·GRT^{1/2}+a₁₀·GRT^{1/3}+a₁₁·GRT^{2/3}+a₁₂·LOA+a₁₃·LOA^{1/2}+a₁₄·LOA^{1/3}+a₁₅·LOA^{2/3}+a₁₆·LOA²+a₁₆·LOA³

Initial values may be presumed and corrected based on comparisons to historical data until satisfactory coefficients are obtained. In operation, a full set of parameters may be used to calculate the agency fee or any non-tariffed item. In some embodiments, helper functions may approximate cost with fewer variables, for example, and without limitation, using only vessel type and DWT, LOA, gross tonnage, net tonnage, and the like. In some embodiments, a cargo category (DRY or WET) may be employed to divide the datasets for estimations. For example: LOA/GT/NT=aDWTb+c. This allows for data-driven calculations using structured query languages (SQL).

In the example shown, If DWT is null, data averaging may be used. For example, and without limitation, a function such as @dwt_est=(dwtmin+dwtmax)/2, where dwtmin is the 1^{st} decile and dwtmax the 9th, may provide an estimate that is easy to implement in SQL.

### Cost Validation

Certain embodiments may modify the regression behavior to continuously verify the model's accuracy. For example, and without limitation, checking that the agency fee/non-tariffed cost value is within the defined range of a minimum and maximum for a certain group. The cost submitted by an agent may be compared with the historic costs giving priority to the most recent disbursement accounts (DAs) which may also allow for automatic cost adjustment. Costs are then validated using a customized method based on an anomaly detection algorithm. For example, if cost is not present on historical DAs or is present only on a minimal number of DAs, this is flagged for review. If the cost is also outside an acceptable range, then it may also be flagged for review.

### Tariff Calculation

Whenever a tariff is confirmed, the DA may record a comment about the tariff calculation. A simple example might be: Pilotage=DWT×0.1=55,000×0.1=$5,500. Using the similarity algorithm to load similar historical DAs, every cost on the DA might contain the calculation of the tariff in a comment. This comment however cannot simply be copied over because the DWT of the vessel might not be exactly equal to 55,000 and the comment would become invalid, even if the variation on the DWT is minor. Therefore, a natural language processing (NLP) technique may be applied to the comments to replace the “variables” required to make this comment valid for the current DA. For example, and without limitation, if the DA that is being validated has a vessel with DWT of 53,250, the comment would go through the NLP processing, identify the variable and the result, replace 55,000 with 53,250 and the tariff cost to $5,325 from $5,500.

NLP may be effectuated through the use of a rules engine that identifies common words, phrases, and numbers in free-form text and modifies the DA cost estimate based on text added by users. The text may identify an appropriate cost category and the amount of the cost associated with that category. A rules engine may be created using common terminology, values, and currencies to facilitate altering the costs estimate. The rules engine may include conventional NLP tools, including artificial intelligence and statistical methods. Networked APIs designed to effectuate NLP may be coupled to a system and used as a rules engine in certain embodiments.

Other representative examples may include:
1. Some tariffs are based on slabs rather than an equation where the tariff would contain “rules” such as: DWT 0-10,000: $2,500, DWT 10,001-50,000: $5,000 . . .
2. Some tariffs are based on variables that are not fixed. DWT for example is a variable that does not change in whatever tariff it is applied and in which port the vessel goes. However, things like “Pilotage Hours” or “Number of Tugs” are a different story. These variables cannot simply be replaced but estimated using the historical DAs loaded by the similarity algorithm, loaded by the NLP processor and replaced accordingly.

### Synthetic PDAs

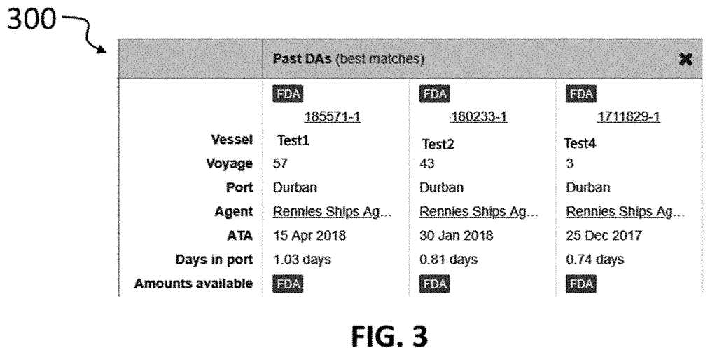

FIG. 3 shows a representation of a user interface 300 which may be employed in some embodiments. FIG. 3 shows the best matches based on past disbursements accounts (DAs). The new agency module should show similar port calls to a shipping agent on the screen allowing a user to manually populate the PDA or, if satisfactory, auto-fill the screen creating a “synthetic” PDA. This will facilitate data entry since the user can easily compare with previous calls or substitute the data entry with an automated process. An agency module (or engine) may include a feature where the agent can pre-fill the PDA values from a selected previous port call determined to be ‘similar’ to one under consideration. This may allow the agent to also modify the copied values but within a certain ruleset to assure correctness.

In certain embodiments, if the predicted tariffed and non-tariffed costs are within a pre-set allowable range, then the synthetic PDA is automatically generated, alleviating the need for user intervention.

### Surcharges

Surcharges vary by port and may take multiple forms. Surcharges are more commonly observed for cost items like pilotage, towage, line handling, and stevedoring rather than cost items like berthing dues or tonnage dues. Surcharges are more probable when the vessel needs to interact with a supervised service such as pilotage, towage, line handling and stevedoring. By way of illustration, only the towage, pilotage, line handling and stevedoring cost items will be used, however, this disclosure should not be limited to exclude any surcharges.

When surcharges are not specified in a vessel's statement of facts (SoF) or other billing documents, alternative means must be employed to ascertain surcharges applied to a port call. For example, and without limitation, the time used for towage and line handling is conventionally a subset of the time used for pilotage. Accordingly, events related to pilotage can be used effectively for gauging the time component for billing. Table 1 shows a representation of events related to pilotage.

TABLE 1
Pilotage

| Event Key | Event Description | Event Type |
|---|---|---|
| 1081 | CARGO DISCHARGING COMMENCED | Cargo |
| 1082 | CARGO DISCHARGING COMPLETED | Cargo |
| 1093 | CARGO LOADING COMMENCED | Cargo |
| 1094 | CARGO LOADING COMPLETED | Cargo |
| 1108 | CHANNEL PILOT DISEMBARKED | Pilotage |
| 1109 | CHANNEL PILOT EMBARKED | Pilotage |
| 1166 | HARBOUR PILOT DISEMBARKED | Pilotage |
| 1167 | HARBOUR PILOT EMBARKED | Pilotage |
| 1226 | PILOT DISEMBARKED | Pilotage |
| 1227 | PILOT EMBARKED | Pilotage |
| 1228 | PILOTAGE COMMENCED | Pilotage |
| 1248 | RIVER PILOT DISEMBARKED | Pilotage |
| 1249 | RIVER PILOT EMBARKED | Pilotage |
| 1257 | SEA PILOT DISEMBARKED | Pilotage |
| 1258 | SEA PILOT EMBARKED | Pilotage |

Once the above events are captured with their associated time/date indication (not shown), the day on which the vessel performed the operations can be easily computed. However, there is often a split between the inward operations and the outward operations. This may be identified using the time required for cargo operations together with the description of the charge. In the example of FIG. 1 tracking the embarkation of a pilot through a voyage is an indication of when a port call commences and ends. Also, cargo discharging is a measure of time between incoming and outgoing vessel operations.

Once the day of the week is identified, the cost items can be allocated to the day of the week using historical port inbound and outbound vessel operations. For example, and without limitation, if there is a history of pilotage charges for vessels entering port on a Sunday and exiting port on a Monday, then that average cost can be compared to historical costs for vessels entering on a Monday and exiting port on a Tuesday. All other factors being equal, the only difference is the inclusion of a Sunday which is likely to incur a weekend surcharge. Similar analysis can be performed limiting the change to only a Saturday or a holiday. International maritime operations reflect different holidays and days of the week for surcharges, therefore historical data for a single port will reflect the proper surcharge day. In some embodiments, the amount of surcharge may be estimated by subtracting the lowest cost from the highest cost.

Similarly, historic cost can be analyzed for different categories of vessels on different days and for different services charges (i.e. towage, pilotage, cargo handling, and the like). Vessels may have a single day turn-around which when analyzed will show a normal rate for charges if on a weekday and possibly a double surcharge on a Sunday. Likewise, a historic cost for vessels having two or more days in port can be processed to isolate a single day likely to have surcharges applied and compared to average costs for days unlikely to have surcharges.

In operation, a collection of historical port calls may be analyzed without foreknowledge of holiday surcharges. The presence of higher costs days of the week (or days in the year) as compared to lower costs days may be an indica of a surcharge. Accordingly, large amounts of historical data may be analyzed using the techniques described herein to identify holidays and other periods of surcharge.

Surcharge validity may be estimated by analyzing whether the involvement of the weekend/holidays/night-shift causes a rise in cost. However, if this condition is satisfied across multiple cost items, then the terminal may be considered to have surcharges associated with it. A surcharge confidence score may be calculated to assess if it is the terminal or time that is subject to a surcharge. The score may depend on various factors such as the number of port calls the location has handled or the variation in the minimum and maximum price ranges observed for the cost item, or keywords found in the comments on the DA level. To eliminate the terminals which show no surcharges algorithmically, the terminals which exhibit additional charges over the weekend are first filtered out. This may be done by filtering out terminals which exhibit high costs only on weekends i.e., Saturday and Sunday. Once filtered these terminals are then subjected to the price variation as well as a port call count test to create a surcharge score.

Once surcharges are estimated, voyages may be scheduled to avoid surcharges by delaying the timing of arrival or accelerating departure schedules. Operation in the proper window, by avoiding tariffs, is one of the benefits of this disclosure.

The above illustration provides many different embodiments or embodiments for implementing different features of the invention. Specific embodiments of components and processes are described to help clarify the invention. These are, of course, merely embodiments and are not intended to limit the invention to that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and, in a manner, consistent with the scope of the invention, as set forth in the following claims.

What is claimed:

1. A system for generating synthetic proforma disbursement accounts including:
a structured data store, said data store including historical port call cost information for both tariffed and non-tariffed costs;
a similarity engine operable to compare historical tariffed items against a proposed port call disbursement account to estimate a tariffed item cost;
a correlation engine, said correlation engine operable to estimate, based on historical costs, a cost for a non-tariffed port call item;
a natural language processing engine operable to identify text entries associated with port costs and translate the text entries to categorized costs,
wherein the estimated costs for categorized costs, non-tariffed items and the tariffed item costs effectuate a synthetic proforma disbursement account.

2. The system of claim 1 wherein the similarity engine compares port call matches by initially applying a first set of rules and altering those rules until enough similar disbursement accounts are identified.

3. The system of claim 1 wherein the non-tariffed port call item cost is estimated by a regression analysis of historical costs.

4. The system of claim 1 wherein the non-tariffed port call item cost is estimated by a correlation model of historical non-tariffed port call costs.

5. The system of claim 4 wherein the correlation model includes:
a matrix, said matrix correlating location information with non-tariffed item cost information, wherein the correlation engine performs a linear regression to calculate non-tariffed port costs.

6. The system of claim 1 wherein the system further includes:
a display engine operable to present the synthetic proforma disbursement to a user and receive a modifying input from the user.

7. One or more processor-readable storage devices containing non-transitory processor-readable instructions directing a processor to perform a method including:
querying a structured data store, said data store including historical port call cost information for both tariffed and non-tariffed costs;
calculating a similarity value between historical tariffed items and a proposed port call disbursement account in response to said querying, and
generating a synthetic proforma in response to the calculating.

8. The devices of claim 7 wherein the similarity is calculated by applying a first set of rules and altering those rules until a similar disbursement account is identified.

9. The devices of claim 7 wherein the method further includes:
predicting a non-tariffed port call item cost by applying a regression analysis of historical costs.

10. The devices of claim 7 wherein the method further includes:
predicting a non-tariffed port call item cost using a correlation model of historical non-tariffed port call costs.

11. The devices of claim 10 wherein the method further includes:
correlating location information with non-tariffed item cost, wherein the correlation engine performs a linear regression to calculate non-tariffed port costs.

12. The devices of claim 7 further including:
displaying the synthetic proforma disbursement to a user, and
receiving a modifying input from the user.
